(19) United States
(12) Patent Application Publication
(10) Pub. No.: US 2006/0044478 A1
(43) Pub. Date: Mar. 2, 2006

(54) Television remote controls and systems utilizing same

(75) Inventor: Yen Jen Chen, Taipei (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/192,798

(22) Filed: Jul. 29, 2005

(30) Foreign Application Priority Data
Aug. 26, 2004 (TW) TW93125476

(51) Int. Cl. H04N 5/44; H04N 5/91

(52) U.S. Cl. 348/734; 386/46

(57) ABSTRACT

Television remote controls and system utilizing same for controlling a television. The television remote control comprises a wireless communication unit and an audio interface coupled to the wireless communication unit. The wireless communication unit initiates a wireless communication channel with the television and receives audio data from the television through the wireless communication channel. The audio interface receives the audio data and outputting audio of the audio data.

### BACKGROUND

The present invention relates to a wireless communication, and in particular to television remote controls.

Conventionally, a television remote control communicates with a television via infrared signaling for channel selection, volume adjustment, power on/off functions. With increasing number of enhanced features provided by digital television, remote controls are accordingly required to provide more control functions.

The infrared signaling between a television and a television remote control, which respectively comprise an infrared receiver and an infrared transmitter is typically interfered with relative positions and angles. Additionally, infrared signaling bandwidth is inadequate for media data transmission, thus further limiting the development of various communication functions.

Losing or misplacing a television remote control may be a frequent-occurring problem, and no function is provided for locating a lost or misplaced television remote control.

Additionally, a conventional television is capable of providing sound to a limited area by transmitting audio signals through speakers thereof. A conventional television remote control has no mechanism for providing sound to an individual when a situation does not permit the television speakers to emit sound.

### SUMMARY

Television remote controls and systems utilizing the same are provided. An exemplary embodiment of a television remote control for controlling a television comprises a wireless communication unit and an audio interface coupled to the wireless communication unit. The wireless communication unit initiates a wireless communication channel with the television and receives audio data from the television through the wireless communication channel. The audio interface receives the audio data and outputting sound based on the audio data.

Another disclosed embodiment of a television remote control for controlling a television comprises a wireless communication unit and a speaker coupled to the wireless communication unit. The wireless communication unit initiates a wireless communication channel and receives a beacon signal from the television through the wireless communication channel. The speaker emits sound in response to the beacon signal.

Further disclosed is an embodiment of a television system comprising a television and a television remote control. The television remote control initiates a wireless communication channel with the television system, receives audio data from the television through the wireless communication channel, and outputs sound based on the audio data.

### DESCRIPTION OF THE DRAWINGS

Television remote controls and systems utilizing the same can be more fully understood by reading the subsequent detailed description and examples with references made to the accompanying drawings, wherein:

FIG. 1 is a schematic diagram of an exemplary embodiment of a television and a television remote control;

FIG. 2 is a block diagram of an exemplary configuration of a television remote control;

FIG. 3 is a block diagram of an exemplary configuration of a television;

FIG. 4 is a flowchart of an exemplary search operation;

FIG. 5 is a flowchart of an exemplary audio signal receiving function;

FIG. 6 is a flowchart of an exemplary audio storing and playing operation;

FIG. 7 is a flowchart of an exemplary operation of trackball module 7; and

FIG. 8 is a flowchart of an exemplary television state reporting operation.

### DETAILED DESCRIPTION

Televisions and television remote controls with advanced wireless communication and control functions are provided.

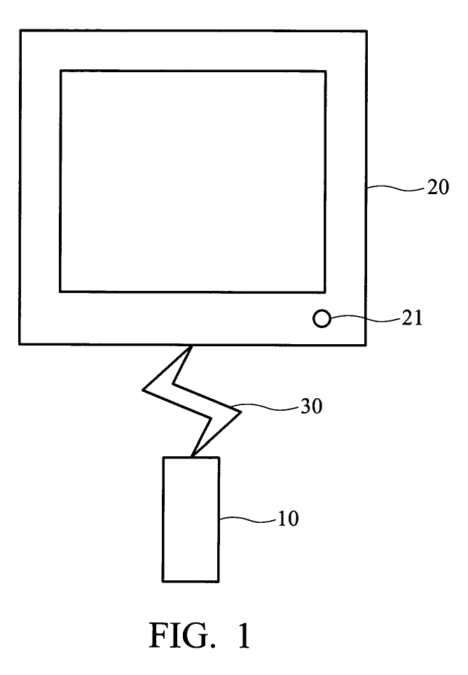

In FIG. 1, wireless communication channel 30 enables interaction between television 20 and television remote control 10 within a certain range regardless of relative angles. In the following, channel 30 or any wireless communication channel functioning as channel 30 is referred to as a universal directional channel of television 20 and television remote control 10 within a range. The range may vary, such as 2 meters, 100 meters, 1 kilometer and the like. For example, channel 30 may be implemented by radio frequency channels or Bluetooth techniques to support a universal directional channel of television 20 and television remote control 10 within a range of 80 meters. Channel 30 may be described as, but not limited to a radio frequency channel in the following.

Television 20 comprises button 21 for generating a beacon signal to assist in locating television remote control 10. The operation of button 21 is described later. Button 21 may be replaced by any input device providing similar or identical operations. An On Screen Display (OSD) may also be used to generate the previously-mentioned beacon signals.

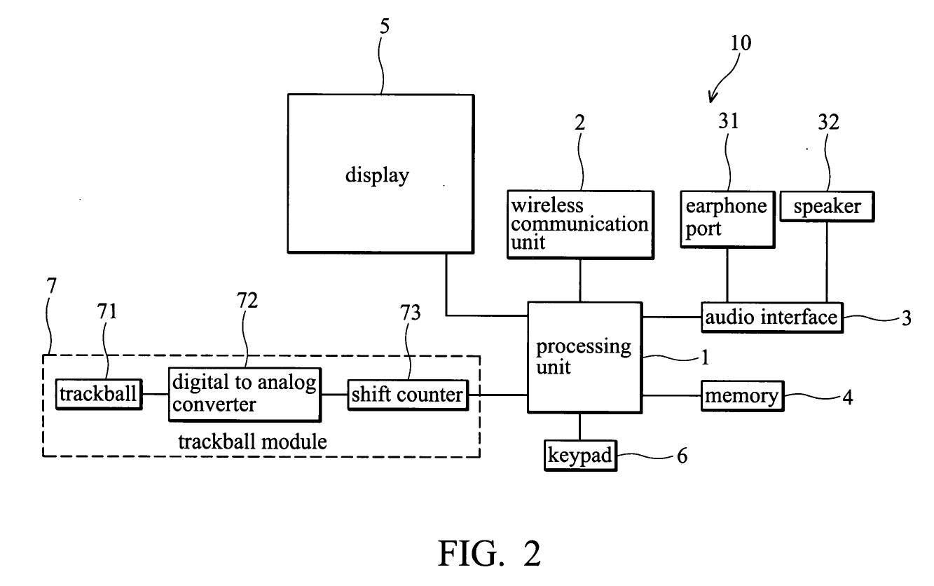

In FIG. 2, television remote control 10 comprises. processing unit 1, wireless communication unit 2, audio interface 3, memory 4, display 5, keypad 6 and trackball module 7. Processing unit 1 couples to and controls wireless communication unit 2, audio interface 3, memory 4, display 5, keypad 6 and trackball module 7.

Wireless communication unit 2 initiates channel 30 and communicates wirelessly with television 20 through channel 30. Audio interface 3 comprises an earphone port 31 and a speaker 32. When an earphone is attached, earphone port 31 outputs audio signals. Speaker 32 emits audio signals at higher volumes than the earphone. Processing unit 1 may determine through earphone port 31 and/or speaker 32 whether output audio signal.

Memory 4 stores various data, such as a program for controlling television remote control 10. Display 5 displays various information, such as status of television 20 or that of television remote control 10. Keypad 6 serves as a user interface for generating various signals to control television 20 and television remote control 10.

Trackball module 7 is another user interface comprising a trackball 71, digital to analog (DA) converter 72, and a shift counter 73. DA converter 72 and a shift counter 73 couples to processing unit 1. The configuration and operations of trackball module 7 is given as an example and is not intended to limit the invention.

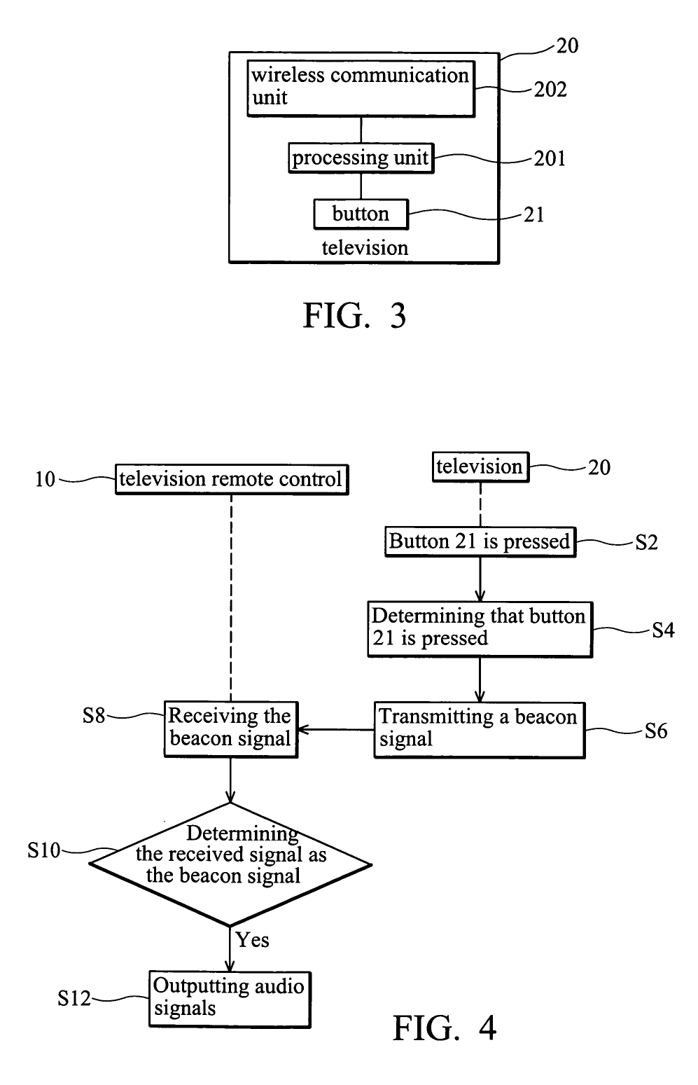

As shown in FIG. 3, processing unit 201 couples to wireless communication unit 202 and button 21. Wireless communication unit 202 initiates channel 30 for communication with wireless communication unit 2. Various functions provided by television 20 and television remote control 10 is described in the following.

Fundamental Functions:

Television remote control 10 may provide several fundamental functions, such as controlling the power on/off state, audio level of television 20, and channel selection. Keypad 6 may comprise functional keys corresponding to fundamental functions and later described functions. Keypad 6, trackball module 7, or an OSD may activate the fundamental functions according to user operation.

Discovery Functions:

FIG. 4 is a flowchart of an exemplary discovery operation.

When button 21 is pressed (step S2), processing unit 201 determines that button 21 is pressed (step S4). Next, processing unit 201 transmits a beacon signal through channel 30 utilizing wireless communication unit 202 (step S6). In television remote control 10, when wireless communication unit 2 receives the beacon signal from wireless communication unit 202 through channel 30 (step S8), processing unit 1 determines the received signal as the beacon signal (step S10). Processing unit 1 outputs audio signals utilizing speaker 32 in response to the beacon signal (step S12).

For example, channel 30 may be initiated as a universal directional channel of television 20 and television remote control 10 in a home environment. When television remote control 10 is lost, a beacon signal can be activated by button 21. When television remote control 10 outputs audio signals in response to the beacon signal, television remote control 10 may be located based on the audio signals.

Audio Signal Reception From Television:

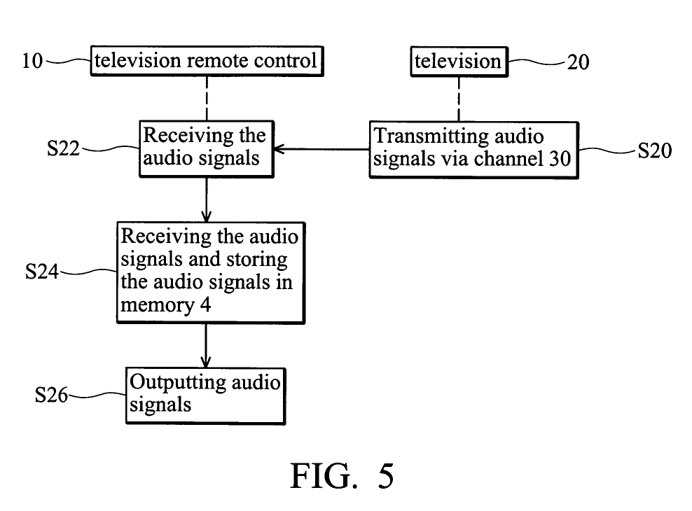

Referring now to FIG. 5, in television 20, processing unit 201 utilizes wireless communication unit 202 to transmit audio signals via channel 30 (step S20). In television remote control 10, wireless communication unit 2 receives the audio signals from television 20 through channel 30 (step S22) and transfers the received audio signals to processing unit 1. Processing unit 1 receives the audio signals and stores the audio signals in memory 4 (step S24). Processing unit 1 transfers the audio signals to audio interface 3. When receiving the audio signals, audio interface 3 outputs the audio signals via earphone port 31 and/or speaker 32 (step S26). Note that processing unit 1 may transfer the audio signals to audio interface 3 without storing the audio signals.

Thus, television remote control 10 is capable of receiving audio signals from television 20 through channel 30 and outputting the received audio signals.

Storing and Playing Audio Data:

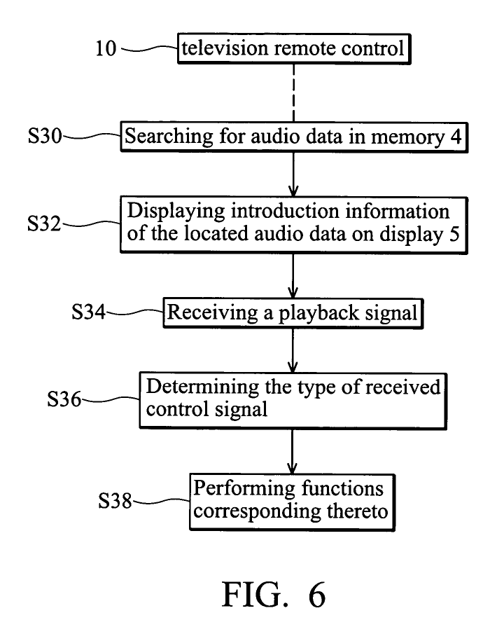

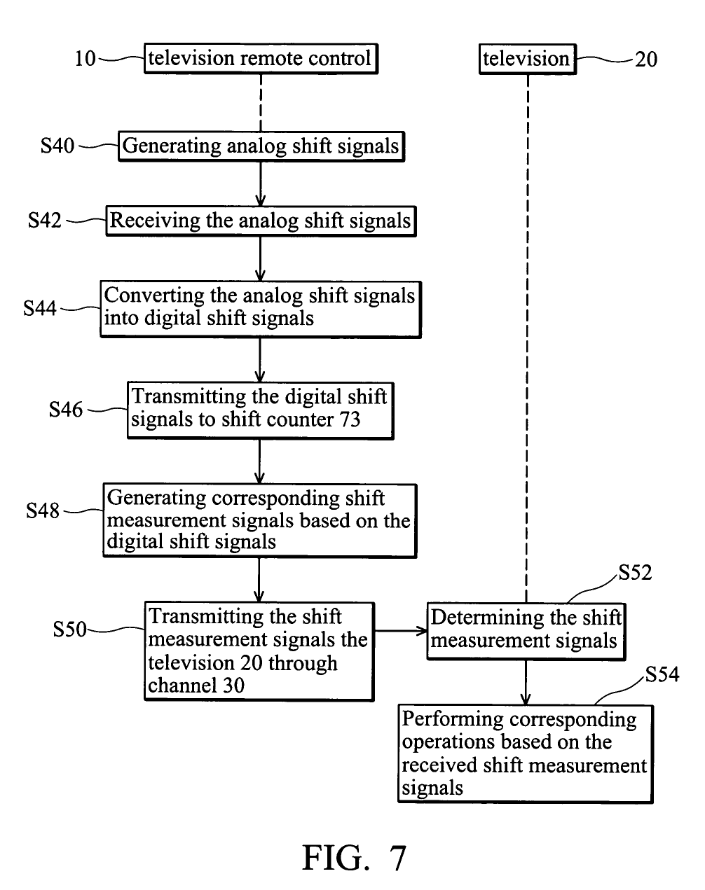

As shown in FIG. 6, memory 4, a rewriteable memory, in television remote control 10 can store audio data. For example, processing unit 1 may store audio data received by wireless communication unit 2 from television 20 or other devices, such as a computer, in memory 4. Television remote control 10 may receive and store audio data conforming to MPEG-1 Audio Layer-3 (MP3) format or other formats.

First, processing unit 1 searches for and then locates audio data in memory 4 (step S30) and presents introduction information of the located audio data on display 5 (step S32). The introduction information may comprise a file name or duration of the located audio data. Keypad 6 may be used to generate control signals for editing an audio data playlist, selecting audio data, playing audio data, and adjusting various audio data playback parameters. For example, processing unit 1 receives a signal from keypad 6 (step S34) for controlling or related to audio data playback. Note that processing unit 1 may receive the control signal from other input device, such as a touch screen, trackball module 7, or wireless communication unit 2. Next, processing unit 1 determines the type of received control signal (step S36) and performs functions corresponding thereto (step S38).

For example, processing unit 1 receives an audio playback signal from keypad 6, then retrieves audio data from memory 4, and outputs the audio data utilizing earphone port 31 or speaker 32 based on the audio playback signal.

For example, display 5 comprises a touch screen by which audio playing may be triggered.

Thus, television remote control 10 provides audio data storage and playback functions.

Wireless Trackball

As shown in FIG. 7, trackball 71 generates analog shift signals when operated (step S40). AD converter 72 receives the analog shift signals (step S42), then converts the analog shift signals into digital shift signals (step S44), and transmits the digital shift signals to shift counter 73 (step S46). Shift counter 73 enumerates the digital shift signals to generate corresponding shift measurement signals (step S48) and then transmits the shift measurement signals to processing unit 1. Processing unit 1 utilizes wireless communication unit 2 to transmit the shift measurement signals the television 20 through channel 30 (step S50). Wireless communication unit 202 receives the shift measurement signals and transfers the shift measurement signals to processing unit 1. After receiving the shift measurement signals, processing unit 201 determines the shift measurement signals (step S52) and performs corresponding operations, such as moving a cursor on the screen of television 20 (step S54).

Thus, television remote control 10 can provide wireless trackball functions.

Reporting Status of Television

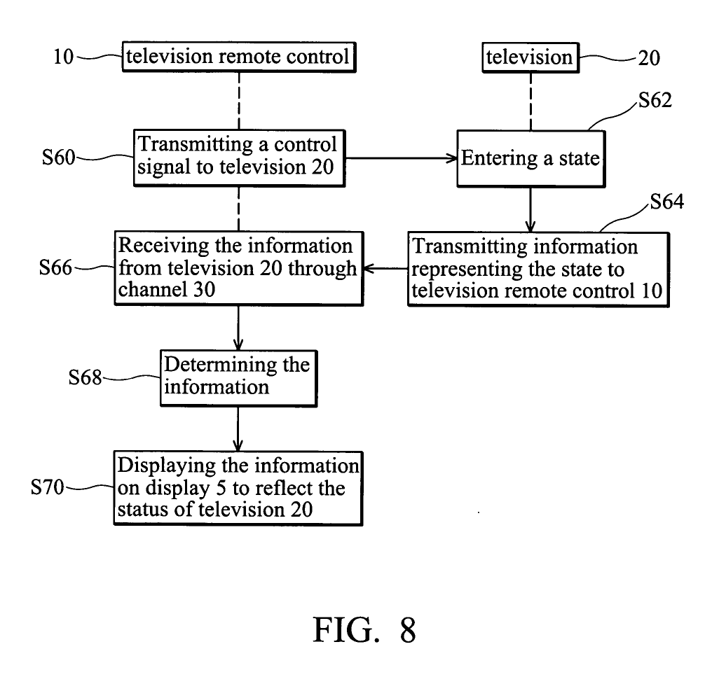

As shown in FIG. 8, when interacting with television 20, television remote control 10 transmits a control signal to television 20 (step S60). After receiving the control signal, television 20 performs a corresponding function in response to the control signal and enters a state (step S62). Television 20 transmits information representing the state to television remote control 10 (step S64). For example, television remote control 10 transmits television 20 to a mute state. Television 20 enters the mute state and transmits information reflecting the mute state to television remote control 10.

Processing unit 1 utilizes wireless communication unit 2 to receive the information from television 20 through channel 30 (step S66). Processing unit 1 determines the information (step S68) and displays the information on display 5 to reflect the status (such as the mute state) of television 20 (step S70).

Display 5 can reflect the states of television 20. Thus, the status of television 20 can be monitored using display 5 without requiring the screen of television 20. Channel 30 and the function for reflecting status of television 20 enable the monitoring of television 20 to be controlled under conditions where the screen of television 20 cannot be observed. When television 20 integrates other electronics, television remote control can also reflect the status thereof.

Thus, television remote control 10 can reflect status of television 20.

Other Functions

Television remote control 10 can be used to operate other functions of television 20, such as security monitoring, accessing to the Internet, or sending emails.

Thus, the disclosed television remote control can potentially offer added functionality when compared with the conventional technology.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A television remote control for controlling a television, comprising:
a wireless communication unit for initiating a wireless communication channel with the television and receiving audio data from the television through the wireless communication channel; and
an audio interface coupled to the wireless communication unit, receiving the audio data and outputting sound based on the audio data.

2. The television remote control as claimed in claim 1, wherein the wireless communication channel comprises a radio frequency channel.

3. The television remote control as claimed in claim 1, wherein the audio interface comprises an earphone port.

4. The television remote control as claimed in claim 1, wherein the audio interface comprises a speaker.

5. The television remote control as claimed in claim 4, wherein the wireless communication unit receives a beacon signal from the television, and the speaker outputs sound in response to the beacon signal.

6. The television remote control as claimed in claim 1, further comprising:
a memory storing audio data;
an input device generating a signal for playing the audio data; and
a processing unit coupled to the wireless communication unit, the memory, and the input device, retrieving the audio data from the memory and outputting sound based on the audio data via the audio interface.

7. The television remote control as claimed in claim 1, wherein the wireless communication unit receives information reflecting the status of the television through the wireless communication channel, and the television remote control further comprises a display coupled to the wireless communication unit, presenting the status of the television according to the received information.

8. The television remote control as claimed in claim 1, further comprising a trackball coupled to the wireless communication unit, generating shift measurement signals and transmitting the shift measurement signals to the television via the wireless communication unit and the wireless communication channel.

9. A television remote control for controlling a television, comprising:
a wireless communication unit for initiating a wireless communication channel and receiving a beacon signal from the television through the wireless communication channel; and
a speaker emitting sound in response to the beacon signal.

10. The television remote control as claimed in claim 9, wherein the wireless communication channel comprises a radio frequency channel.

11. The television remote control as claimed in claim 9, further comprising a trackball coupled to the wireless communication unit, generating shift measurement signals and transmitting the shift measurement signals to the television via the wireless communication unit and the wireless communication channel.

12. The television remote control as claimed in claim 9, wherein the wireless communication unit receives information reflecting the status of the television through the wireless communication channel, and the television remote control further comprises a display coupled to the wireless communication unit, presenting the status of the television according to the received information.

13. The television remote control as claimed in claim 9, further comprising:
a memory storing audio data;
an input device generating a signal for playing the audio data; and
a processing unit coupled to the wireless communication unit, the memory, and the input device, retrieving the audio data from the memory and outputting sound based on the audio data via the audio interface.

14. A television system, comprising:
a television; and
a television remote control for initiating a wireless communication channel with the television system, receiving audio data from the television through the wireless communication channel, and outputting sound based on the audio data.

15. The television system as claimed in claim 14, wherein the wireless communication channel comprises a radio frequency channel.

16. The television system as claimed in claim 14, wherein the television remote control comprises at least an earphone port or a speaker.

17. The television system as claimed in claim 16, wherein the television remote control receives a beacon signal from the television through the wireless communication channel, and the speaker outputs sound in response to the beacon signal.

18. The television system as claimed in claim 16, wherein the television remote control further comprises a memory storing audio data, an input device generating a signal for playing the audio data, and a processing unit coupled to the wireless communication unit, the memory, and the input device, retrieving the audio data from the memory and outputting audio of the audio data via the earphone port or the speaker.

19. The television system as claimed in claim 14, wherein the television remote control receives information reflecting the status of the television through the wireless communication channel, and the television remote control further comprises a display presenting the status of the television according to the received information.

20. The television system as claimed in claim 14, wherein the television remote control further comprises a trackball generating shift measurement signals and transmitting the shift measurement signals to the television through the wireless communication channel.
